(19) United States
(12) Patent Application Publication
(10) Pub. No.: US 2023/0121522 A1
(43) Pub. Date: Apr. 20, 2023

(54) Polyimide Polymer

(71) Applicants: Brandon S. Farmer, Huntsville, AL (US); David L. Rodman, Huntsville, AL (US); Lonnie F. Bradburn, JR., Huntsville, AL (US); Rachel A. Farmer, Huntsville, AL (US)

(72) Inventors: Brandon S. Farmer, Huntsville, AL (US); David L. Rodman, Huntsville, AL (US); Lonnie F. Bradburn, JR., Huntsville, AL (US); Rachel A. Farmer, Huntsville, AL (US)

(21) Appl. No.: 17/966,125

(22) Filed: Oct. 14, 2022

Related U.S. Application Data
(60) Provisional application No. 63/255,691, filed on Oct. 14, 2021.

(51) Int. Cl. C08G 73/10

(52) U.S. Cl. CPC C08G 73/1078

(57) ABSTRACT

A method of producing a polyimide polymer comprising reacting at least two dianyhydride monomers with at least two diamino monomers in a first solvent under conditions appropriate to form a polyamic acid and subsequently imidized through one or more methods to a polyimide polymer.

### CROSS REFERENCE TO RELATED APPLICATIONS

This application claims priority to, and the benefit of, pending U.S. Provisional Application No. 63/255,691 filed Oct. 14, 2021.

### FIELD OF INVENTION

The invention relates to high performance polymers. In particular, this invention relates to polyimide polymers, which have many desirable properties, such as thermal stability and strength.

### BACKGROUND OF THE INVENTION

Polyimides are an important class of polymeric materials and are known for their superior performance characteristics. These characteristics include high glass transition temperatures, good mechanical strength, high Young’s modulus, good UV durability, and excellent thermal stability. Most polyimides are comprised of relatively rigid molecular structures such as aromatic/cyclic moieties.

As a result of their favorable characteristics, polyimide compositions have become widely used in many industries, including the aerospace industry, the electronics industry and the telecommunications industry. In the electronics industry, polyimide compositions are used in applications such as forming protective and stress buffer coatings for semiconductors, dielectric layers for multilayer integrated circuits and multi-chip modules, high temperature solder masks, bonding layers for multilayer circuits, final passivating coatings on electronic devices, and the like. In addition, polyimide compositions may form dielectric films in electrical and electronic devices such as motors, capacitors, semiconductors, printed circuit boards and other packaging structures. Polyimide compositions may also serve as an interlayer dielectric in both semiconductors and thin film multichip modules. The low dielectric constant, low stress, high modulus, and inherent ductility of polyimide compositions make them well suited for these multiple layer applications. Other uses for polyimide compositions include alignment and/or dielectric layers for displays, and as a structural layer in micromachining applications.

In the aerospace industry, polyimide compositions are used for optical applications as membrane reflectors and the like. In this application, a polyimide composition is secured by a metal (often aluminum, copper, or stainless steel) or composite (often graphite/epoxy or fiberglass) mounting ring that secures the border of the polyimide compositions. Such optical applications may be used in space, where the polyimide compositions and the mounting ring are subject to repeated and drastic heating and cooling cycles in orbit as the structure is exposed to alternating periods of sunlight and shade.

### SUMMARY OF THE INVENTION

The current invention includes a polyimide polymer with a polymeric backbone. The current invention also includes a method for producing the polyimide polymer herein described.

Other aspects and advantages of the invention will be apparent from the following description and the appended claims.

### BRIEF DESCRIPTION OF THE DRAWINGS

FIG. 1 depicts the formation of an amic acid.

FIG. 2 depicts the formation of an imide bond from an amic acid.

FIG. 3 depicts 4-4′-[hexafluoroisopropylidene] diphthalic anhydride [6-FDA].

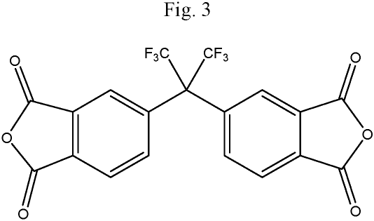

FIG. 4 depicts 2,2′-Bis(trifluoromethyl)-4,4′-diamino biphenyl (TFMB).

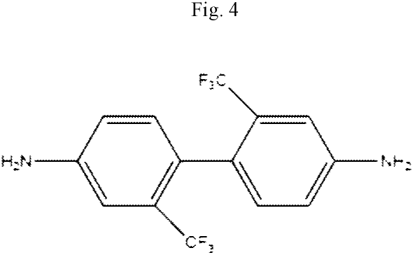

FIG. 5 depicts 2,2′ Dimethyl 4-4′ diaminobiphenyl [DMB].

FIG. 6 depicts pyromellitic dianhydride [PMDA].

NOTE: The use of waved lines “〰” indicates the molecule continues, but does not necessarily repeat. The use of square brackets “[“ and/or” indicates that the structure repeats beyond the bracket. The use of round brackets “(“and/or”)” indicates substructures within a repeat unit and does not indicate the substructure repeats beyond the round brackets. In this description, an atom AA shown connected to a phenyl group through a bond, instead of at the angles representing carbon atoms, is meant to depict the atom AA connects to any available carbon atom in the phenyl group, and not to a specific carbon atom. Therefore, such a drawing does not specifically denote an ortho, meta, or para positioning of the bond to the AA atom.

### DETAILED DESCRIPTION

### Polyimide

Polyimides are a type of polymer with many desirable characteristics. In general, polyimide polymers include a nitrogen atom in the polymer backbone, wherein the nitrogen atom is connected to two carbonyl carbons, such that the nitrogen atom is somewhat stabilized by the adjacent carbonyl groups. A carbonyl group includes a carbon, referred to as a carbonyl carbon, which is double bonded to an oxygen atom. Most polyimides are considered an AA-BB type polymer because two different classes of monomers are used to produce the polyimide polymer. One class of monomer is called an acid monomer, and is usually in the form of a dianhydride. The other type of monomer is usually a diamine, or a diamino monomer. Polyimides may be synthesized by several methods. In the traditional two-step method of synthesizing aromatic polyimides, a polar aprotic solvent such as N-methylpyrrolidone (NMP) is used. First, the diamino monomer is dissolved in the solvent, and then a dianhydride monomer is added to this solution. The diamine and the acid monomer are generally added in approximately a 1:1 molar stoichiometry.

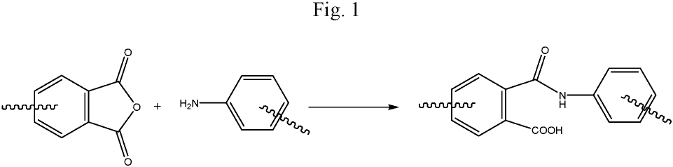

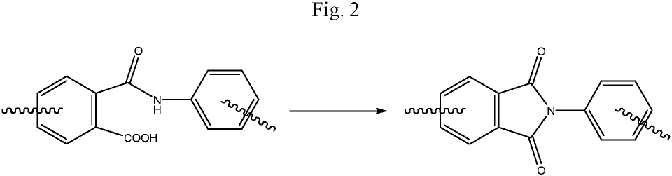

Because one dianhydride monomer has two anhydride groups, different diamino monomers can react with each anhydride group so the dianhydride monomer may become located between two different diamino monomers. The diamine monomer contains two amine functional groups; therefore, after one amine attaches to the first dianhydride monomer, the second amine is still available to attach to another dianhydride monomer, which then attaches to another diamine monomer, and so on. In this matter, the polymer backbone is formed. The resulting polycondensation reaction forms a polyamic acid. The reaction of an anhydride with an amine to form an amic acid is depicted in FIG. 1. The high molecular weight polyamic acid produced is soluble in the reaction solvent and, thus, the solution may be cast into a film on a suitable substrate such as by flow casting. The cast film can be heated to elevated temperatures in stages to remove solvent and convert the amic acid groups to imides with a cyclodehydration reaction, also called imidization. Alternatively, some polyamic acids may be converted in solution to soluble polyimides by using a chemical dehydrating agent, catalyst, and/or heat. The conversion of an amic acid to an imide is shown in FIG. 2.

The polyimide polymer is usually formed from two different types of monomers, and it is possible to mix different varieties of each type of monomer. Therefore, one, two, or more dianhydride-type monomers can be included in the reaction vessel, as well as one, two or more diamino monomers. The total molar quantity of dianhydride-type monomers is kept about the same as the total molar quantity of diamino monomers. Because more than one type of diamine or dianhydride can be used, the exact form of each polymer chain can be varied to produce polyimides with desirable properties.

For example, a single diamine monomer AA can be reacted with two dianhydride comonomers, B₁B₁ and B₂B₂, to form a polymer chain of the general form of (AA-B₁B₁)ₓ-(AA-B₂B₂)_{y} in which x and y are determined by the relative incorporations of B₁B₁ and B₂B₂ into the polymer backbone. Alternatively, diamine comonomers A₁A₁ and A₂A₂ can be reacted with a single dianhydride monomer BB to form a polymer chain of the general form of (A₁A₁-BB)ₓ-(A₂A₂-BB)_{y}. Additionally, two diamine comonomers A₁A₁ and A₂A₂ can be reacted with two dianhydride comonomers B₁B₁ and B₂B₂ to form a polymer chain of the general form (A₁A₁-B₁B₁)_{w}-(A₁A₁-B₂B₂)ₓ-(A₂A₂-B₁B₁)_{y}-(A₂A₂-B₂B₂)_{z}, where w, x, y, and z are determined by the relative incorporation of A₁A₁-B₁B₁, A₁A₁-B₂B₂, A₂A₂-B₁B₁, and A₂A₂-B₂B₂ into the polymer backbone. Therefore, one or more diamine monomers can be polymerized with one or more dianhydrides, and the general form of the polymer is determined by varying the amount and types of monomers used.

The dianhydride is only one type of acid monomer used in the production of AA-BB type polyimides. It is possible to use different acid monomers in place of the dianhydride. For example, a tetracarboxylic acid with four acid functionalities, a tetraester, a diester acid, or a trimethylsilyl ester could be used in place of the dianhydride. In this description, an acid monomer refers to either a dianhydride, a tetraester, a diester acid, a tetracarboxylic acid, or a trimethylsilyl ester. The other monomer is usually a diamine, but can also be a diisocyanate. Polyimides can also be prepared from AB type monomers. For example, an aminodicarboxylic acid monomer can be polymerized to form an AB type polyimide.

The characteristics of the polyimide polymer are determined, at least in part, by the monomers used in the preparation of the polymer. The proper selection and ratio of monomers are used to provide the desired polymer characteristics. For example, polyimides can be rendered soluble in organic solvents by selecting the monomers that impart solubility into the polyimide structure. It is possible to produce a soluble polyimide polymer using some monomers that tend to form insoluble polymers if the use of the insoluble monomers is balanced with the use of sufficient quantities of soluble monomers, or through the use of lower quantities of especially soluble monomers. The term especially soluble monomers refers to monomers which impart more of the solubility characteristic to a polyimide polymer than most other monomers. Some soluble polyimide polymers are soluble in relatively polar solvents, such as dimethylacetamide, dimethylformamide, dimethylsulfoxide, tetrahydrofuran, acetone, methyl ethyl ketone, methyl isobutyl ketone, and phenols, as well as less polar solvents, including chloroform, and dichloromethane. The solubility characteristics and concentrations of the selected monomers determine the solubility characteristics of the resultant polymer. For this description, a polymer is soluble if it can be dissolved in a solvent to form at least a 1 percent solution of polymer in solvent, or more preferably a 5 percent solution, and most preferably a 10 percent or higher solution.

Most, but not all, of the monomers used to produce polyimide polymers include aromatic groups. These aromatic groups can be used to provide an attachment point on the polymer backbone for a tether. A tether refers to a chain including at least one carbon, oxygen, sulfur, phosphorous, or silicon atom that is used to connect the polymer backbone to another compound or sub-compound. Therefore, if the polymer backbone were connected through the para position on a phenyl group, wherein the para position refers to the number 1 and the number 4 carbons on the benzene ring, the ortho and meta positions would be available to attach a tether to this polymer backbone. The ortho position to the number 1 carbon refers to the number 2 and number 6 carbons, whereas the meta position to the number 1 carbon refers to the number 3 and number 5 carbons.

Many polyimide polymers are produced by preparing a polyamic acid polymer in the reaction vessel. The polyamic acid is then formed into a sheet or a film and subsequently processed with heat (often temperatures higher than 250° C.) or both heat and catalysts to convert the polyamic acid to a polyimide. However, polyamic acids are moisture sensitive, and care must be taken to avoid the uptake of water into the polymer solution. Additionally, polyamic acids exhibit self-imidization in solution as they gradually convert to the polyimide structure. The imidization reaction generally reduces the polymer solubility and produces water as a by-product. The water produced can then react with the remaining polyamic acid, thereby cleaving the polymer chain. Moreover, the polyamic acids can generally not be isolated as a stable pure polymer powder. As a result, polyamic acids have a limited shelf life.

Sometimes it is desirable to produce the materials for a polyimide polymer film, but wait for a period of time before actually casting the film. For this purpose, it is possible to store either a soluble polyimide or a polyamic acid. Soluble polyimides have many desirable advantages over polyamic acids for storage purposes. Soluble polyimides are in general significantly more stable to hydrolysis than polyamic acids, so the polyimide can be stored in solution or it can be isolated by a precipitation step and stored as a solid material for extended periods of time. If a polyamic acid is stored, it will gradually convert to the polyimide state and/or hydrolytically depolymerize. If the stored material becomes hydrolytically depolyermized, it will exhibit a reduction in solution viscosity, and if the stored material converts to the polyimide state, it will become gel-like or a precipitated solid if the polyimide is not soluble in the reaction medium. This reduced viscosity solution may not exhibit sufficient viscosity to form a desired shape, and the gel-like or solid material cannot be formed to a desired shape. The gradual conversion of the polyamic acid to the polyimide state generates water as a byproduct, and the water tends to cleave the remaining polyamic acid units. The cleaving of the remaining polyamic acid units by the water is the hydrolytic depolymerization referred to above. Therefore, the production of soluble polyimides is desirable if there will be a delay before the material is formed for final use.

Soluble polyimides have advantages over polyamic acids besides shelf life. Soluble polyimides can be processed into usable work pieces without subjecting them to the same degree of heating as is generally required for polyamic acids. This allows soluble polyimides to be processed into more complex shapes than polyamic acids, and to be processed with materials that are not durable to the 250 degree Celsius minimum temperature typically required for imidizing polyamic acids. To form a soluble polyimide into a desired film, the polyimide is dissolved in a suitable solvent, formed into the film as desired, and then the solvent is evaporated. The film solvent can be heated to expedite the evaporation of the solvent.

### Selection of Monomers

The characteristics of the final polymer are largely determined by the choice of monomers which are used to produce the polymer. Factors to be considered when selecting monomers include the characteristics of the final polymer, such as the solubility, thermal stability and the glass transition temperature. Other factors to be considered include the expense and availability of the monomers chosen. Commercially available monomers that are produced in large quantities generally decrease the cost of producing the polyimide polymer film since such monomers are in general less expensive than monomers produced on a lab scale and pilot scale. Additionally, the use of commercially available monomers improves the overall reaction efficiency because additional reaction steps are not required to produce a monomer which is incorporated into the polymer. One advantage of the current invention is the preferred monomers are generally produced in commercially available quantities, which can be greater than 10,000 kg per year.

One type of monomer used is referred to as the acid monomer, which can be either the tetracarboxylic acid, tetraester, diester acid, a trimethylsilyl ester, or dianhydride. The use of the dianhydride is preferred because it generally exhibits higher rates of reactivity with diamines than tetrafunctional acids, diester acids, tetraesters, or trimethylsilyl esters. Some characteristics to be considered when selecting the dianhydride monomer include the solubility of the final polymer as well as commercial availability of the monomers.

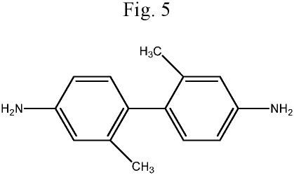

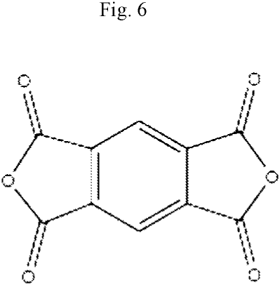

The preferred dianhydride monomers of the current invention are 2,2′-Bis-(3,4-Dicarboxyphenyl) hexafluoropropane dianhydride6-FDA and Pyromellitic dianhydride PMDA, as seen in FIGS. 5 and 6, but other dianhydride monomers may also be used. Biphenyltetracarboxylic Dianhydride (s-BPDA), oxyphthalic dianhydride (ODPA), 3,3′,4,4′-Benzophenone tetracarboxylic dianhydride, (BTDA), 3,3′,4,4′ - Diphenylsulfone tetracarboxylic dianhydride (DSDA).

The monomers 2,2′ Dimethyl 4-4′ diaminobiphenyl DMB and 2,2′-bis(trifluoromethyl)benzidine TFMB, as shown in FIGS. 7 and 8, are the preferred diamine monomers of the current invention, but other diamine monomers may be used. Many other diamino monomers can be used, including but not limited to 2,2-bis[4-(4-aminophenoxy) phenyl]hexafluoropropane (BDAF), 1,3 bis(3-aminophenoxy) benzene (APB), 3,3-diaminodiphenyl sulfone (3,3-DDS02), 4,4′-diaminodiphenylsulfone (4,4′-DDS02), meta phenylene diamine (m-PDA), para phenylene diamine (p-PDA), oxydianiline (ODA), the isomers of 4,4′-Methylenebis(2-methylcyclohexylamine) (MBMCHA), the isomers of 4,4′-Methylenebis(cyclohexylamine), (MBCHA), the isomers of 1,4-cyclohexyldiamine (CHDA), 1,2-diaminoethane, 1,3-diaminopropane, 1,4-diamonbutane, 1,5-diaminopentane, 1,6-diaminohexane, and diamonodurene (DMDE), 3,5 Diaminobenzoic Acid (DBA).

The monomers may be mixed in a variety of ratios. In one embodiment the ratio is between 60-95:40-5%/60-95-40-5% of acid monomer 1:diamine monomer1 to acid monomer 2:diamine monomer 2. In one preferred embodiment the ratio is between 75-95:25-5%/75-95:25-5% of acid monomer 1:diamine monomer1 to acid monomer 2:diamine monomer 2

### Process

The process for creating the final polymer should involve as few reactions and as few isolations as possible to maximize the overall efficiency. A general procedure is outlined below - of course those of skill in the art will recognize that there are additional or different steps and processes that may be used. A specific example is provided further below. Minimization of the number of vessels or pots which are used during the production process also tends to improve efficiency, because this tends to minimize the number of reactions and/or isolations of the polymer.

The first step is forming the polyimide polymer backbone. Some of the basic requirements for this polymer backbone are that it be soluble, that it include an attachment point, and that it has many of the desirable characteristics typical of polyimide polymers. Typically, the diamino monomers will be dissolved in a solvent, such as dimethylacetamide [DMAc]. After the diamino monomers are completely dissolved, the dianhydride monomers is added to the vessel and allowed to react for approximately 4 to 24 hours. The use of an end capping agent, such as a monoanhydride or a monoamine, is not preferred until after the polymerization reaction is allowed to proceed to completion. At that point, the addition of phthalic anhydride or other monoanhydride end-capping agents can be used to react with remaining end group amines. Adding end capping agents during the polymerization reaction tends to shorten the polymer chains formed, which can reduce desirable mechanical properties of the resultant polymer. For example, adding end capping agents during the polymerization reaction can result in a more brittle polymer, due to lower molecular weight.

At this point the monomers have reacted together to form a polyamic acid. It is desired to convert the polyamic acid to a polyimide. The conversion of the polyamic acid to the polyimide form is known as imidization, and is a condensation reaction which produces water, as seen in FIG. 2. Because water is a by-product of a condensation reaction, and reactions proceed to an equilibrium point, the removal of water from the reaction system pushes or drives the equilibrium further towards a complete reaction because the effective concentration of the by-product water is reduced. This is true for chemical reactions generally, including condensation reactions.

The water can be removed from the reaction vessel chemically by the use of anhydrides, such as acetic anhydride, or other materials which will react with the water and prevent it from affecting the imidization of the polyamic acid. Water can also be removed by evaporation. One imidization method involves the use of a catalyst to chemically convert the polyamic acid to the polyimide form. A tertiary amine such as pyridine, triethyl amine, and / or beta-picolline is frequently used as the catalyst. Another method previously discussed involves forming the polyamic acid into a film which is subsequently heated, known as thermal imidization. This will vaporize water as it is formed, and imidize the polymer.

A third imidization method involves removing the formed water via azeotropic distillation. The polymer is heated in the presence of a small amount of catalyst, such as isoquinoline, and in the presence of an aqueous azeotroping agent, such as xylene, to affect the imidization. The method of azeotropic distillation involves heating the reaction vessel so that the azeotroping agent and the water distill from the reaction vessel as an azeotrope. After the azeotrope is vaporized and exits the reaction vessel, it is condensed and the liquid azeotroping agent and water are collected. If xylene, toluene, or some other compound which is immiscible with water is used as the azeotroping agent, it is possible to separate this condensed azeotrope, split off the water for disposal, and return the azeotroping agent back to the reacting vessel.

An alternate possibility is to remove the water via azeotropic distillation from the reaction vessel. This can be done by adding or by continuing to use an azeotroping agent such as xylene or toluene, then vaporizing the water, separating the water from the reaction vessel, and discarding the water after it has exited the reaction vessel. This is similar to the process described above for the imidization reaction.

The current process includes up to two isolations of the polyimide polymer. The first possible isolation is after the polymer imidization reaction, and the second possible isolation is after the OS group has been attached to the polyimide polymer. The azeotropic removal of water in the vapor formed during a condensation reaction eliminates the need for a subsequent isolation. Therefore, if vaporous water is azeotropically removed during one of either the polymer imidization reaction or the OS attachment reaction, the number of isolations needed for the production of the final OS containing polymer is reduced to one. If vaporous water is removed after both of the above reactions, it is possible to produce the final product with no isolations.In one embodiment where the ratios of TFMB to DMB is 80/20 and the ratio of 6FDA and PMDA is 80/20, a random polymer of the repeating units w, x, y and z below is created.

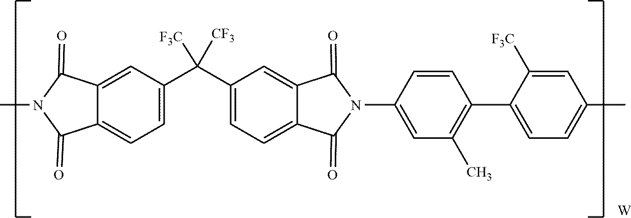

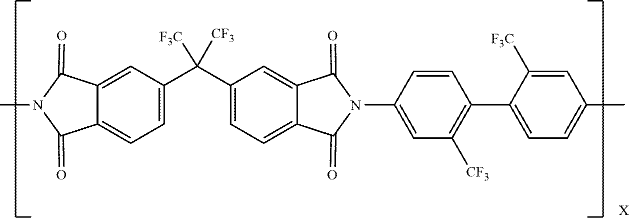

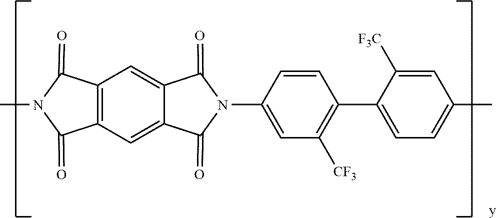

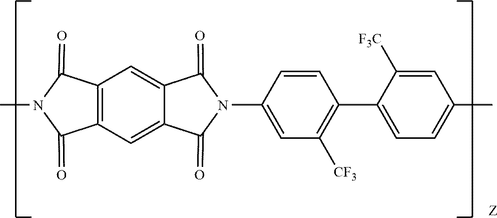

### Polymer Uses

The polyimide polymer produced as described above can be used for several specific purposes. One important characteristic to consider is the color of the polymer. Polyimide polymers usually absorb the shorter wavelengths of light up to a specific wavelength, which can be referred to as the 50% transmittance wavelength (50% T). Light with wavelengths longer than the 50% transmittance wavelength are generally not absorbed and pass through the polymer or are reflected by the polymer. The 50% T is the wavelength at which 50% of the electromagnetic radiation is transmitted by the polymer. The polymer will tend to transmit almost all the electromagnetic radiation above the 50% T, and the polymer will absorb almost all the electromagnetic radiation below the 50% T, with a rapid transition between transmittance and adsorption at about the 50% T wavelength. If the 50% T can be shifted to a point below the visible spectrum, the polymer will tend to be very clear, but if the 50% T is in or above the visible spectrum, the polymer will be colored.

Generally, the factors that increase the solubility of a polymer also tend to push the 50% T lower, and thus tend to reduce the color of a polymer. Therefore, the factors that tend to reduce color in a polymer include flexible spacers, kinked linkages, bulky substituents, and phenyl groups which are aligned in different planes. The current invention provides a polyimide polymer with very little color.

A polyimide polymer with low color is useful for several applications. For example, if a polyimide is used as a cover in a multi layer insulation blanket on a satellite, the absence of color minimizes the amount of electromagnetic radiation that is absorbed. This minimizes the heat absorbed when the polymer is exposed to direct sunlight. Temperature variations for a satellite can be large, and a clear polyimide polymer, especially one that is resistant to AO degradation, provides an advantage.

Display panels need to be clear, so as not to affect the quality of the displayed image. The current invention is useful for display panels. In addition to optical clarity, a display panel should have low permeability to water and oxygen, a low coefficient of thermal expansion, and should be stable at higher temperatures. Thermal stability at 200 degrees centigrade is desired, but stability at 250 degrees centigrade is preferred, and stability at 300 degrees centigrade is more preferred. Polyimide films tend to be very strong, so they can be used as protective covers. For example, sheets of polyimide film can be placed over solar panels to protect the panels from weather and other sources of damage. For a solar panel to operate properly, it has to absorb sunlight. Polyimide polymers with low color are useful to protect solar panels, and other items where a view of the protected object is desired.

### Examples

### Example 1

In this example, polyamic acid was made in a dried glass reactor produced with a mixer and one mixing blade. The glass reactor was dried in a force air oven at 125° C. for minimum of one hour to remove any moisture from the glass. A Nitrogen or Argon needle was used in the reactor to prevent water from being introduced into the polymerization. Before the reaction took place, the dianhydrides were dried to remove any moisture that may have been draw out of the air. The 4, 4′ -Hexafluoroisopropylidene (Diphthalic Anhydride, 6FDA) was dried in a vacuum oven at 160° C. for ten hours. The Pyromellitic Dianhydride (PMDA) was dried in a vacuum oven at 110° C. for ten hours.

Into the dried glass reactor 6.96 grams of 2, 3-Dimethyl-1, 3-butadiene (DMB) was measured out. Next, 41.81 grams of 2, 2′-Bis(trifluoromethyl)-4, 4′ -biphenyldiamine (TFMB) was added into the glass reactor with the DMB. Approximately half of the total amount of Dimethylacetamide (DMAc) was then poured into the glass container (243.055 grams) holding the solute. The diamines were then allowed to dissolve completely in the DMAc using a mixer with one blade set at 130 RPM.

Once the amines were dissolved, the dianhydrides were measured. First, 7.12 grams of PMDA were measured into a 200 x-long speed mixing cup. Next, 58.01 grams of 6FDA was measure out. Then the remaining DMAC was obtained (243.055 grams).

Removing one of the septa from the glass reactor, a funnel was used to pour the dianhydrides into the glass reactor. Once the anhydrides were in the glass reactor, the 243.055 grams of DMAc was used to wash any leftover anhydrides off the funnel and sides of the glass reactor. After the remainder of the DMAc was added, the contents of the glass reactor was left to mix overnight at 150 RPM.

The following day the polyamic acid in the glass reactor was imidized. Imidization took place by measuring out 50.37 grams of Acetic Anhydride (A.A) and 38.72 grams of Pyridine into a speed mixing cup. Using a funnel, the A.A. and Pyridine were then poured into the glass reactor containing the dianhydrides and diamines. The resin was then left to immidize overnight at 150 RPM.

The succeeding day the resin was precipitated in deionized water using a homogenizer. The powder then proceeded to be washed in deionized water three times. Upon the third rinsing the powder was placed into a tray to be placed in the force air oven for drying. The polymer dried in the oven for ten hours at 125° C., eight hours at 160° C., and four hours at 200° C.

The thus obtained polymer was then turned back into a resin for testing. Gamma- Butyrolactone (GBL) was the chosen solvent to dissolve the polymer. From the polymer and the GBL a 16.66% solid, 100 mL resin was produced for casting a film used for the various testing.

The film was cast at zero rotations per minute and spun until dry, with one drying light, at 105 RPM. No release agent was used for casting. After the film was dry, it was taped and placed in the oven to be cured. The cure temperature being a one hour soak at 100° C., a one hour soak at 200° C., and a one hour soak at 300° C.

The resulting polymer had a T_{g} of approximately 340.43° C., a yellowness index of approximately 3.70, a CTE of about 38.12 (um/m*C) and was about 9 um thick. The T_{g}, yellowness and CTE were measured as described below:

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated. As used herein, the singular forms “a”, “an” and “the” are intended to include the plural forms as well, unless the context clearly indicates otherwise.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A method of producing a polyimide polymer comprising reacting at least two dianyhydride monomers with at least two diamino monomers in a first solvent under conditions appropriate to form a polyamic acid and subsequently imidized through one or more methods to a polyimide polymer.

2. The method of claim 1 wherein the dianhydride monomers are 4-4′-hexafluoroisopropylidene (6FDA) and pyromellitic dianhydride (PMDA). And the wherein the diamino monomers are 2,2′ imethyl 4-4′ diaminobiphenyl (DMB) and 2,2′-bis(trifluoromethyl)benzidine (TFMB).
